(19) United States
(12) Patent Application Publication
(10) Pub. No.: US 2009/0299744 A1
(43) Pub. Date: Dec. 3, 2009

(54) VOICE RECOGNITION APPARATUS AND METHOD THEREOF

(75) Inventor: Mitsuyoshi TACHIMORI, Kawasaki (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/423,215

(22) Filed: Apr. 14, 2009

(30) Foreign Application Priority Data
May 29, 2008 (JP) 2008-140944

(51) Int. Cl. G10L 15/00

(52) U.S. Cl. 704/250; 704/E15.001

(57) ABSTRACT

A voice recognition apparatus determines whether an input sound is a voice segment or a non-voice segment in time series, generates a word model for the voice segment, allocates a predetermined non-voice model for the non-voice segment, connects the word model and the non-voice model in sequence according to the time series of the segments of the input sound corresponding to the respective models and generates a vocalization model, and coordinates the vocalization model with a vocalization ID in one-to-one correspondence, and stores the same.

### CROSS-REFERENCE TO RELATED APPLICATION

This application is based upon and claims the benefit of priority from the prior Japanese Patent Application No. 2008-140944, filed on May 29, 2008; the entire contents of which are incorporated herein by reference.

### FIELD OF THE INVENTION

The present invention relates to a voice recognition apparatus that is able to generate a word model from an input voice from a user and register the model as an object recognition vocabulary, and a method thereof.

### DESCRIPTION OF THE BACKGROUND

As an example which enables generation of a word model from an input voice from a user and registration of the model as an object recognition vocabulary, for example, a voice recognition apparatus disclosed in Japanese Patent No. 3790038 is exemplified. In this voice recognition apparatus, a sub word string is calculated for an input voice, and the sub word string is registered as a word model. The term “subword” means a partial word as shown in Japanese Patent No. 3790038.

In this method in the related art, there arise following problems when registering a series of word string vocalized with a pause therebetween specifically under an environment with noise.

For example, when registering a personal name as a full name, the user vocalizes the full name often with a pause (by interspacing) between a family name and a first name unconsciously like “family name/pause/first name”. The sign “/” represents a segmentation between words inserted for the sake of convenience in notation, and “/” does not exist in the vocalized voice.

In the method in the related art, ideally, “a sub word string indicating the family name+a non-voice string+a sub word string indicating the first name” is outputted for the input voice having the pause inserted therebetween as descried above. The term “non-voice string” in this specification means a sub word string which indicates a non-voice model learned by a sound other than the voice. In general, the voice recognition apparatus possesses one or more non-voice models Na, Nb, . . . , and outputs strings such as “Nb, Na, Na, Nc, Nb” as the non-voice string.

However, realistically, there may arise erroneous recognition such that the pause portion matches better a voice model than the non-voice model. When such the erroneous recognition occurs, an outputted sub word string will be “a sub word string which indicates the family name+a sub word string which indicates some voice+a sub word string which indicates the first name”, and the sub word string which indicates a voice (voice sub ward string) is disadvantageously generated at a portion which should be a non-voice.

Furthermore, the voice sub word string which matches the non-voice portion as described above differs significantly depending on the type of noise which exists in the non-voice portion. Therefore, even though a vocalization of “family name/pause/first name” is registered under a certain environment with noise, and then the completely same vocalization is recognized under another environment with noise, matching between the sub word string at the time of registration and that at the time of recognition at the pause portion cannot be achieved properly, so that there arises a problem of occurrence of erroneous recognition.

As described thus far, there is a problem of occurrence of the erroneous recognition due to the matching of the voice sub word string with the non-voice portion.

### SUMMARY OF THE INVENTION

In view of such problems as described above, the invention provides a voice recognition apparatus in which probabilities of erroneous recognition due to mismatching of a sub word string in a pause segment is reduced, and a method thereof.

According to embodiments of the invention, there is provided a voice recognition apparatus including: an input unit configured to input a sound; a determining unit configured to determine whether an inputted input sound is a voice segment or a non-voice segment in time series; a generating unit configured to generate a vocalization model by generating a word model for the voice segment, allocating a predetermined non-voice model for the non-voice segment, and connecting the word model and the non-voice model in sequence according to the time series of the segments of the input sound corresponding to the respective models, and a registering unit configured to store the vocalization model with a vocalization ID in one-to-one coordination.

According to the invention, since the non-voice model is forcedly allocated for the segments determined as the non-voice when generating the vocalization model, the sub word string is not generated in the pause segment. Accordingly, erroneous recognition by mismatching of the sub word strings in the pause segment described in the description of the background is reduced.

### BRIEF DESCRIPTION OF THE DRAWINGS

FIG. 1 is a drawing showing a configuration of a voice recognition apparatus according to a first embodiment of the invention.

FIG. 2 is a drawing showing the voice recognition apparatus according to a second embodiment.

FIG. 3 is a first flowchart according to a third embodiment.

FIG. 4 is a second flowchart according to the third embodiment.

FIGS. 5A and 5B are drawings of a left-to-right type HMM in a first output state from among three output states.

FIGS. 6A and 6B are drawings of the left-to-right type HMM in a second output state from among the three output states.

FIGS. 7 A and 7B are drawings of the left-to-right type HMM in a third output state from among the three output states.

### DETAILED DESCRIPTION OF THE INVENTION

Referring now to the drawings, a voice recognition apparatus 10 according to a first embodiment of the invention will be described.

### First Embodiment

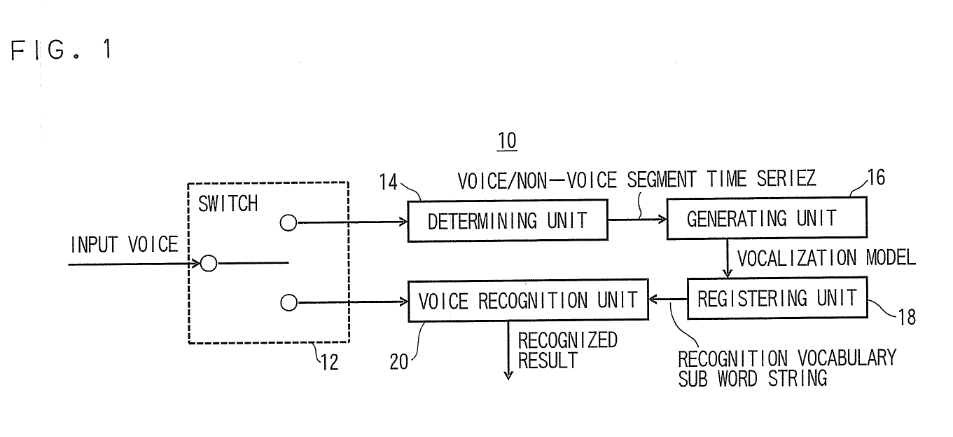

Referring now to FIG. 1, the voice recognition apparatus 10 according to the first embodiment of the invention will be described.

An example of the configuration of the voice recognition apparatus 10 according to the first embodiment is shown in FIG. 1.

As shown in FIG. 1, the voice recognition apparatus 10 includes a switch 12, a determining unit 14, a generating unit 16, a registering unit 18, and a voice recognition unit 20.

The respective components from 12 to 20 may also be implemented by a program transmitted to or stored in a computer.

The switch 12 is configured to switch an operation between normal voice recognition when being connected to the voice recognition unit 20 and vocabulary registration when being connected to the determining unit 14 for an input sound, and the connection is specified by a user.

The determining unit 14 determines the input sound whether it is a voice or a non-voice. A method of determination therefor will be described in sequence.

First of all, a time to start the input sound is assumed to be “t=1”. Voice segment detection is started from the time 1, and whether or not a voice segment is detected is confirmed at respective times t. A detailed method of detecting the voice segment may be employed from a method disclosed in JP-A-2007-114413 KOKAI, for example. For example, segments having at least a reference volume are determined as a voice segment, and segments having volumes less than the reference volume are determined as a non-voice segment. It is also possible to determine sounds within a specific frequency band as the voice segment, and sounds in other bands as the non-voice segment.

Subsequently, under a condition of “time t=T1”, it is assumed that a voice segment S1=[s1, e1] (where 1<=s1<e1<=T1) is detected. At this time, if a segment N1=[1, s1−1] which is a segment before the voice segment S1 exists, that is, if s1>1 is satisfied, the segment N1 is determined as the non-voice segment.

Subsequently, going back to the next time “t=e1”+1 of the voice segment which is detected now, the voice segment detection is started again.

Subsequently, it is assumed that a voice segment S2=[s2, e2] (where s2>e1) is detected under the condition of “time T2 (T2>T1). It is also assumed that a segment N2=[e1+1, s2−1] between the previously detected voice segment and the current segment is a non-voice segment.

If s2=e1+1 is satisfied, the segment of a combination of the voice segments S1 and S2 is a continuous single segment [s1, e2], and if it is considered as S1 anew, it may be considered to be a segment immediately after having detected s1. Therefore, in order to avoid an unnecessary complication, it is assumed that a non-voice segment always exists between two different voice segments in the following description.

In the manner as described above, every time when the voice segment is detected, a process to repeat the voice detection to return back to the next time “t=e1+1” next to the voice segment detected now is repeated until no more voice segment is detected at the time “t=T”.

If the segment exists after a voice segment Sn=[sn, en] which is detected lastly, that is, if en<T, Nn+1=[en+1, T] is determined as a non-voice segment.

A voice and non-voice segment train N1, S1, N2, S2, . . . Nn, Sn, Nn+1 obtained by the process described thus far is outputted to the generating unit 16.

First of all, the generating unit 16 calculates a sub word string for the respective detected voice segments S1 to Sn.

Here, the sub word string obtained from a voice segment Sk is assumed to be Wk=“Pk₁, Pk₂, . . . . Pkₘₖ”, where Pk₁ and so on are a single sub word.

As a detailed method of calculating the sub word string, a method disclosed in Japanese Patent No. 3790038 may be employed.

The sub word which indicates the non voice is represented by φ, and a single φ is applied to any of the non-voice segments N1 to Nn+1 uniformly.

A vocalization model is assumed to be a sub word string which includes all the sub word strings combined into one string according to the temporal sequence of the corresponding voice and non-voice segment, “φW₁φW₂ . . . φWₙφ”, that is, “φP1₁P1₂ . . . P1ₘ₁φP2₁P2₂ . . . P21ₘ₂φ . . . φPn₁Pn₂ . . . Pnₘₙφ”.

Now, even though the non-voice segment N1 or Nn+1 exists here, the generating unit 16 may exclude them and generate a vocalization model “P1₁P1₂ . . . P1ₘ₁φP2₁P2₂ . . . P21ₘ₂φ . . . φPn₁Pn₂ . . . Pnₘₙ” for the voice segment train S1, N2, S2, . . . Nn, Sn.

The registering unit 18 issues a vocalization ID of “Sx” labeled by “series numbers x” in sequence of registration for the vocalization model generated in this manner, and stores the same as a word ID of the vocalization model generated now in one-to-one correspondence.

The registering unit 18 includes definitions of sub word strings with respect to predetermined vocabularies stored therein, so that a sub word string Px₁, Px₂, . . . . Pxₐₓ with respect to Vx of the word ID is acquired.

In addition, if there is an instruction from the user, the registering unit 18 deletes the specified vocalization model.

The voice recognition unit 20 carries out the voice recognition using a Hidden Markov Model (HMM).

The voice recognition unit 20 reads object recognition vocabularies and sub word strings of registered vocalization models in sequence from the registering unit 18, and generates words HMMs corresponding to the respective sub words in the same manner as the description in Japanese Patent No. 3790038, Paragraph [0032].

When the switch 12 is connected to the voice recognition unit 20, the input voice is recognized using the words HMMs obtained in this manner and outputs the result of recognition.

According to the first embodiment, by generating the vocalization models, even thought it is a vocalization model generated from the vocalization including a pause, an unnecessary sub word string is not generated in the non-voice segment, so that erroneous recognition is alleviated during the voice recognition.

Although the voice recognition unit 20 is provided in the first embodiment, it is also possible to omit the voice recognition unit 20 and the switch 12 in FIG. 1, and realize the determining unit 14 as an apparatus for simply generating and registering the vocalization models by inputting input sounds directly thereto.

In the case of the apparatus of this type, the registering unit 18 is connected to the external voice recognition apparatus 10, and the registered models are used practically, for example, as a voice recognition vocabulary.

### Second Embodiment

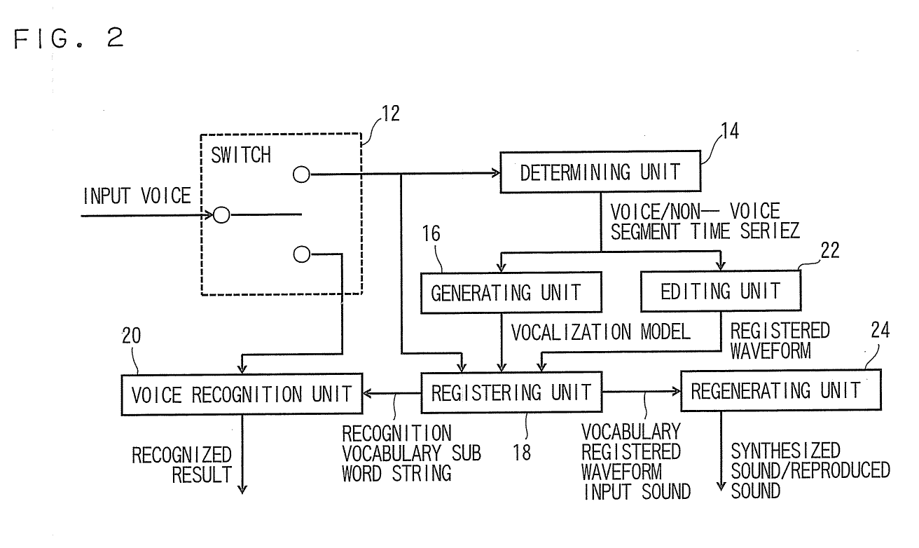

Referring now to FIG. 2, the voice recognition apparatus 10 according to a second embodiment of the invention will be described. In the second embodiment, the voice recognition apparatus 10 having a function to reproduce a voice generated when generating the voice model, and a function to allow the user to confirm his or her own vocalization later will be described.

An example of the configuration of the voice recognition apparatus 10 according to the second embodiment of the invention is shown in FIG. 2.

As shown in FIG. 2, the voice recognition apparatus 10 in the second embodiment includes the switch 12, the determining unit 14, the generating unit 16, an editing unit 22, the registering unit 18, a regenerating unit 24, and the voice recognition unit 20.

Since the switch 12, the determining unit 14, the generating unit 16, and the voice recognition unit 20 are the same as in the first embodiment, the description thereof is omitted, and different configurations will be described.

The editing unit 22 generates signals obtained by replacing waveform signals in the respective segments, which are determined to be the non-voice by the determining unit 14 with predetermined edited waveform signals.

Therefore, the signals generated here include the waveform signals of the input sounds remained without being changed for the voice segments, and those changed to the replaced edited waveform signals for the non-voice segments. The waveforms of the non-voice segments may be of any type, such as replacing the waveform with those whose waveform power (amplitude) is reduced to 1/10, as long as the difference from the input sound is apparent.

The vocalization models are stored in the registering unit 18 by coordinating the word IDs issued as in the first embodiment with one or both of the waveform signals generated by the editing unit 22 and the input signals in one-to-one correspondence. The vocabularies stored in the registering unit 18 each have a model flag for discriminating the vocalization models and the vocabularies registered in advance, and “1” is set to the vocalization models and “0” is set to the vocabularies registered in advance.

The registering unit 18 allows the user to set which one of the corresponding registered waveform and the waveform signal of the input sound is to be coordinated with the vocalization model, or whether both of them are to be coordinated therewith.

Then, the registering unit 18 determines the coordination with the waveform signals according to the user setting.

When deleting the registered vocalization model from the registering unit 18 on the basis of the instruction from the user, the waveform coordinated therewith is also deleted completely.

The regenerating unit 24 retains data required for generating synthesized sounds of the vocabularies registered in advance in the registering unit 18 and, when a word to be reproduced is specified, extracts the corresponding word from the registering unit 18. If its model flag is “0”, the word is read by a voice synthesis, and if this model flag is “1”, the waveform signal which is coordinated with the corresponding word is reproduced.

The regenerating unit 24 allows the user to set the priority of reproduction between the edited waveform signal and the waveform signal of the input sound before edition when both of them are coordinated, and reproduces the signal having the higher priority according to the user setting.

According to the second embodiment, the user is able to conform the vocalization generated at the time of registration and, in addition, which part of the input sound is determined as the non-voice can be confirmed by setting the registered waveform to be reproduced.

Therefore, if the determination in the determining unit 14 is not correct, registration may be tried again after having deleted the model in which the error occurs.

### Third Embodiment

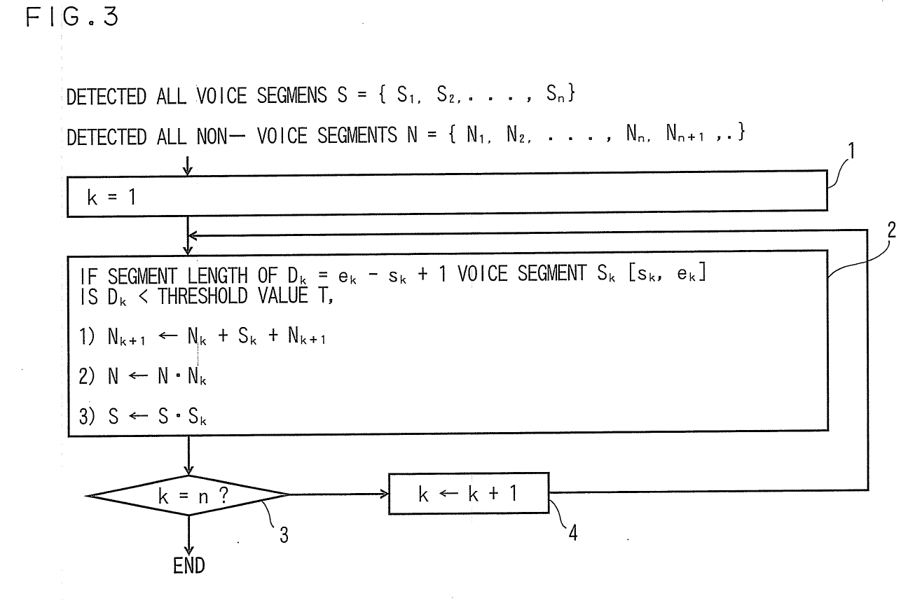

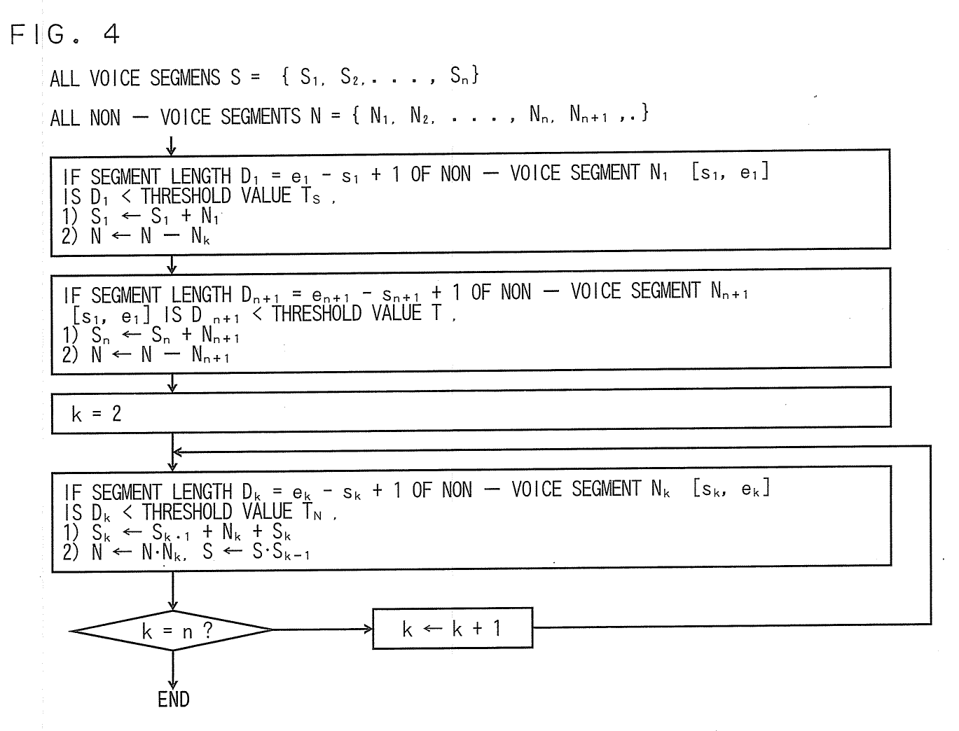

Referring now to FIG. 3 and FIG. 4, the voice recognition apparatus 10 according to a third embodiment will be described.

The configuration of the voice recognition apparatus 10 in the third embodiment is the same as that of the voice recognition apparatus 10 in the first embodiment.

For the sake of easy understanding, a scene in which the third embodiment is applied will be described. In the actual scenes, the following event may occur by hearing the user's vocalization wrong.

For example, if the user fumbles for the right word such as “Toushiba-Tatt-,Tarou” when the user registers a vocabulary, the determining unit 14 determines the tree segments of “Toshiba”, “Tatt”, and “Tarou” as the voice segment.

Here, if the relatively short voice segment such as “Tatt” is treated as a non-voice segment, normal registration of the words is achieved for such the vocalization as a result of fumbling for the right word in the same manner as a case of being vocalized as “Toshiba/pause/Tarou”, which is convenient for the user.

In contrast, even though it is a non-voice segment, if the segment is extremely short segment, the non-voice segment might be better to be ignored and treated as a large voice segment connected to an adjacent voice segment.

Therefore, in the third embodiment, the above-descried process is realized.

A flowchart of a process for the voice segments is shown in FIG. 3.

In Step 1, assuming that the determining unit 14 has detected the set of all voice segments is S={S1, S2, . . . Sn} and the set of all non-voice segments is N={N1, N2, . . . Nn, Nn+1}, the determining unit 14 applies a process on Sk in chronological order, that is, in sequence from k=1. The entire input sound is a segment represented by connecting Nk and Sk alternately, that is, a segment represented as N1+S1+N2+S2+ . . . Sn+Nn+1.

In Step 2, assuming that a start time of the segment Sk is sk, an end time is ek, the determining unit 14 recognizes the segment Sk as a non-voice segment when a segment length Dk=ek−sk+1 is shorter than a predetermined threshold value Ts. Then, the segments Nk, Sk, Nk+1 are all non-voice segments, and are continued segments, the determining unit 14 combines Sk with noise segments Nk, Nk+1 adjacent thereto, and renews the same as a single continuous segment. In other words, the determining unit 14 renews the segment into a segment from a start time of Nk to an end time of Nk+1, and deletes Sk from the set S and Nk from the set N.

In Steps 3 and 4, the determining unit 14 repeats the above-described procedure until k=n. Then, the set S and the set N are renumbered with series numbers from 1 in chronological order again for those remained after the process as described above.

The determining unit 14 performs the process on the voice segments as descried above, and then performs the same process for the non-voice segments. A flowchart of a process for the non-voice segments is shown in FIG. 4. Although there is a small difference in process, it is essentially the same process as for the voice segment, so that the description will be omitted.

Although the process for the set of the voice segments is performed first and then the process for the set of the non-voice segments is performed in the description above, it is possible to carry out the process for the set of the non-voice segments first and then the process for the set of the voice segments after, or it is also possible to carry the process only for one of the set of the non-voice segments and the set of the voice segments.

### Fourth Embodiment

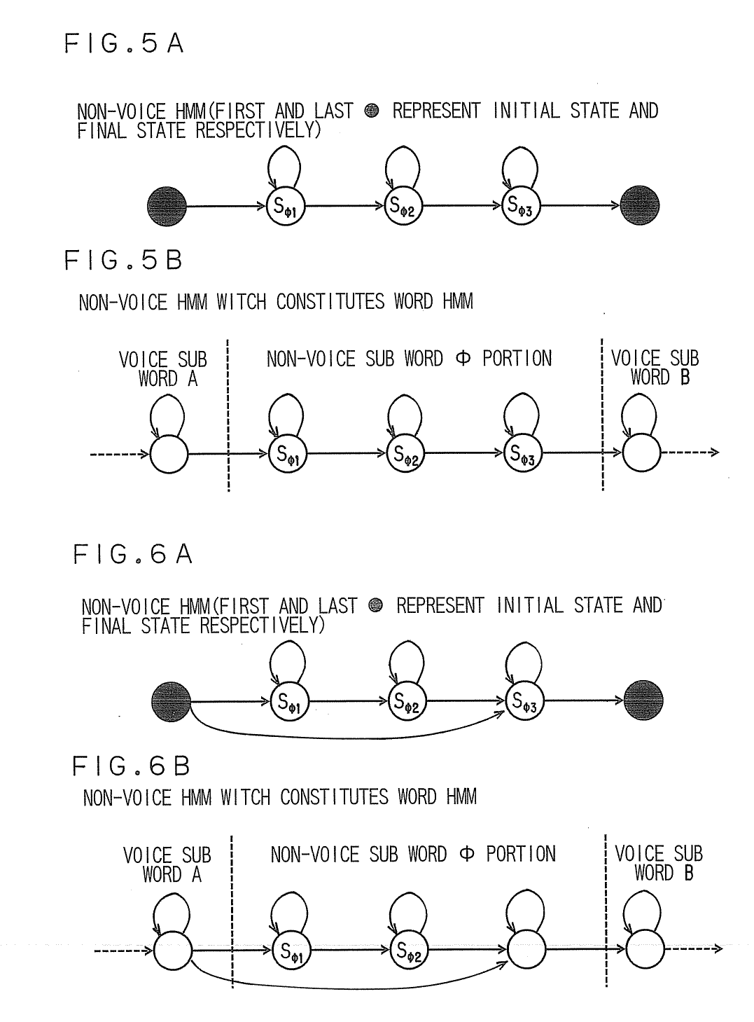

Referring now to FIG. 5 to FIG. 7, the voice recognition apparatus 10 according to a fourth embodiment of the invention will be described.

The configuration of the voice recognition apparatus 10 in the fourth embodiment is the same as that of the voice recognition apparatus 10 in the first embodiment.

The vocalization model (sub word string) registered in the registering unit 18 generates word models corresponding to the sub word string at the time of voice recognition. In the fourth embodiment, since the word model in the first embodiment is the word HMM, the HMM is taken as an example in the fourth embodiment as well.

In the first embodiment, the non-voice segment is represented by the single sub word φ which represents the non-voice. Therefore, assuming that the HMM corresponding to φ is the left-to-right type HMM with three output states (hollow circles in the drawing) as shown in FIG. 5A, in the word model, it is connected as a part of the word HMM as shown in FIG. 5B without the initial state and the final state. In FIG. 5B, a state in which sub words A and B which represent the voices respectively are connected to the front and back of the φ portion is shown.

The HMM which represents the non-voice must not be the left-to-right type as described above, and may be an HMM of a given topology (the connected relation between the states of the HMM) such as so-called Ergodic HMM.

In the fourth embodiment, a sub word string other than this type will be described.

Assuming that a sub word which indicates a repetition of the sub word φ by zero or one time is [φ], and the sub word string to be allocated to the non-voice segment by the generating unit 16 is one sub word [φ].

For example, when there is one non-voice segment existing between two voice segments (the sub word strings corresponding respectively thereto are represented by W1 and W2), a sub word string “W1 [φ] W2” is obtained.

An HMM corresponding to [φ] is shown in FIG. 6A. When integrating this into the word HMM, it is integrated as shown in FIG. 6B. This HMM includes a path which makes a transition in the three output states and an alternative path, which corresponds to the one φ and the zero φ, respectively.

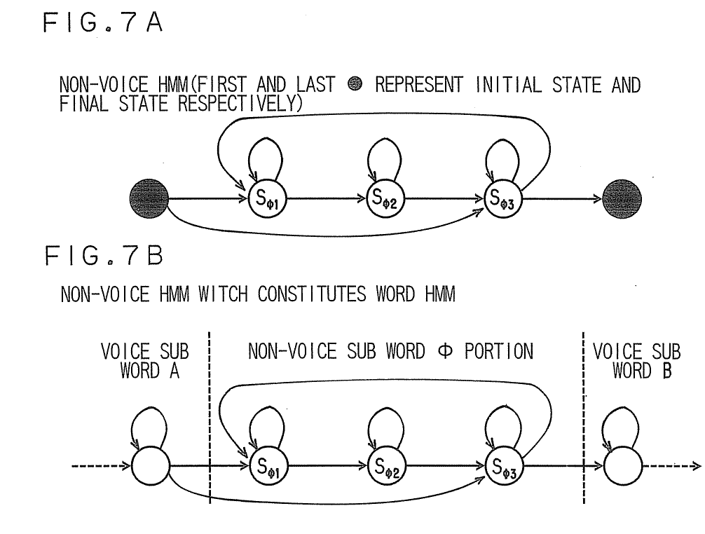

In addition, a sub word φ* which indicates the repetition of the sub word φ by at least zero time may be used. The HMM which realizes the sub word φ* may be configured as shown in FIG. 7A. In FIGS. 7A and 7B, since there is a path returning from the third state to the first state, the φ can be repeated by a given number of times by following this path. When integrating this into the word HMM, it is integrated as shown in FIG. 7B.

In the fourth embodiment, by using the HMM in which the φ can be omitted or which can be repeated, even though the user registers “family name/pause/first name” with a pause inserted in-between at the time of registration and vocalizes only “family name/first name” by omitting the pause at the time of recognition, or even though a long pause is inserted at the time of vocalization, correct recognition is enabled.

### MODIFICATIONS

The invention is not limited to the embodiment described above, and may be modified variously without departing the scope of the invention.

What is claimed is:

1. A voice recognition apparatus comprising:
an input unit configured to input a sound;
a determining unit configured to determine whether an inputted input sound is a voice segment or a non-voice segment in time series;
a generating unit configured to generate a vocalization model by generating a word model for the voice segment, allocating a predetermined non-voice model for the non-voice segment, and connecting the word model and the non-voice model in sequence according to the time series of the segments of the input sound corresponding to the respective models; and
a registering unit configured to store the vocalization model with a vocalization ID in one-to-one correspondence.

2. The apparatus according to claim 1, further comprising:
an editing unit configured to replace a waveform signal of the non-voice segment with a predetermined wave signal to generate an edited waveform signal;
a second registering unit configured to store the vocalization ID of the vocalization model and the edited waveform signal in one-to-one correspondence; and
a regenerating unit configured to call the edited waveform signal corresponding to the vocalization ID specified by a user from the second registering unit and reproducing the same.

3. The apparatus according to claim 1, wherein when a non-voice segment exists at a time before the voice segment whose starting time is the earliest in the input sound, or when the non-voice segment exists at a time after the voice segment whose starting time is the latest in the input sound, the generating unit excludes these non-voice segments and generates the vocalization model.

4. The apparatus according to claim 1, wherein even though a segment is determined as the voice segment, if the length of the segment is shorter than a given time length, the determining unit corrects the determination of the segment as the non-voice segment.

5. The apparatus according to claim 1, wherein even though a segment is determined as the voice segment, if the non-voice segments exist adjacently before and after the segment, the determining unit connects the segment and the non-voice segments before and after the segment and corrects these segments to a block of the non-voice segment.

6. The apparatus according to claim 1, wherein even though a segment is determined as the non-voice segment, if the length of the segment is shorter than a given time length, the determination of the segment is corrected to the voice segment.

7. The apparatus according to claim 1, wherein even though a segment is determined as the non-voice segment, if the voice segments exist adjacently before and after the segment, the determining unit connects the segment and the voice segments before and after the segment and corrects these segments a block of the voice segment.

8. The apparatus according to claim 1, wherein the non-voice model is a sub word indicating the non-voice, and is a sub word which expresses a repetition by at least zero time.

9. The apparatus according to claim 1, wherein the registering unit stores a predetermined object recognition vocabulary, and further includes a voice recognition unit configured to perform voice recognition with the stored vocabulary and the vocalization model as the object recognition vocabularies.

10. A method of voice processing comprising:
inputting a sound;
determining whether an inputted input sound is a voice segment or a non-voice segment in time series;
generating a vocalization model by generating a word model for the voice segment, allocating a predetermined non-voice model for the non-voice segment, and connecting the word model and the non-voice model in sequence according to the time series of the segments of the input sound corresponding to the respective models; and
storing the vocalization model with a vocalization ID in one-to-one correspondence.

11. A voice processing program stored in a computer readable medium, the program realizing functions of;
inputting a sound;
determining whether an inputted input sound is a voice segment or a non-voice segment in time series;
generating a vocalization model by generating a word model for the voice segment, allocating a predetermined non-voice model for the non-voice segment, and connecting the word model and the non-voice model in time series of the segments of the input sound corresponding to the respective models; and
storing the vocalization model with a vocalization ID in one-to-one correspondence.
